(19) United States
(12) Patent Application Publication
(10) Pub. No.: US 2025/0196529 A1
(43) Pub. Date: Jun. 19, 2025

(54) HIGH VOLUME BRANDING SYSTEM

(71) Applicant: T&T CONSULTING AND ENGINEERING, INC., East Dundee, IL (US)

(72) Inventors: Tomas TASSY, SR., East Dundee, IL (US); Antal SUTO, East Dundee, IL (US)

(21) Appl. No.: 19/065,322

(22) Filed: Feb. 27, 2025

Related U.S. Application Data
(63) Continuation-in-part of application No. 18/385,246, filed on Oct. 30, 2023.
(60) Provisional application No. 63/420,325, filed on Oct. 28, 2022.
(60) Provisional application No. 63/558,858, filed on Feb. 28, 2024.

(51) Int. Cl. B44B 7/00; A21D 13/47; A21D 15/04

(52) U.S. Cl. CPC B44B 7/00; A21D 15/04; A21D 13/47

(57) ABSTRACT

A high volume branding system for branding baked goods with a desired indicia. The system includes a branding conveyor for receiving and conveying the baked goods. The system also includes a branding station that includes branding. The branding presses are configured to travel along the branding conveyor in two directions and are configured to align a branding press head with the baked goods on the branding conveyor while they are moving downstream along the branding conveyor. The branding press head includes a branding plate that is heated and lowered onto the baked goods while the branding press is moving downstream along with the baked goods to brand indicia onto the baked goods. After the indicia is branded onto the baked goods, the branding press head and branding plate are raised and the branding press is moved to align the branding press head with additional baked goods on the branding conveyor.

### PRIORITY CLAIM

This application claims priority under 35 U.S.C. § 119(e) to U.S. Provisional Application Ser. No. 63/558,858 filed Feb. 28, 2024 and U.S. application Ser. No. 18/385,246 filed Oct. 30, 2023, which claims priority to U.S. Application Ser. No. 63/420,325 filed Oct. 28, 2022, which are expressly incorporated herein by reference in their entirety.

### FIELD OF THE DISCLOSURE

The present disclosure relates generally to baking equipment, and more specifically to baking equipment used in the commercial baking industry.

### BACKGROUND

The baking industry, specifically the commercial baking industry, produces numerous baked goods such as hamburger buns, hot dog buns, pizza crust, and pita bread, among other items. Adding designs, logos, or wording to the baked goods can be accomplished by printing or branding the baked goods. Such operations take time to accomplish, slowing down the overall production of the baking process. This adds unnecessary time, cost, and complexity to the baked goods. There is a need for a high volume branding system that will allow for the desired branding of baked goods without slowing down the overall commercial baking process to reduce the overall cost of the branded baked goods.

### SUMMARY

The present disclosure may comprise one or more of the following features and combinations thereof.

In illustrative embodiments, the present disclosure is directed to a high speed branding system for branding logos, words, and symbol onto baked goods. The branding system includes a series of conveyors that convey and align baking pans containing unbranded baked goods that are to be branded. The system also includes four branding presses that are part of a branding shuttle that includes a portion that is positioned above baked goods that are traveling on a branding conveyor beneath the branding presses.

In illustrative embodiments, the branding system includes four branding presses that are shuttled upstream and downstream along the branding conveyor to align branding press heads with baking pans positioned beneath. The branding presses include servo motors that are configured to lower the branding press heads downward so that the branding press heads make contact with the baked goods to be branded. Heaters in the branding press heads heat branding press plates so that images, words, or logos can be branded/imprinted onto the baked goods. The branding shuttle is designed to move branding presses downstream in sync with the baking pans positioned below and traveling on the branding conveyor for a certain dwell time so that the images can be properly imprinted onto the bakery goods. Once the dwell time is completed, the branding press heads are raised and the branding shuttle moves the branding presses back upstream to meet up with additional baking pans to brand additional bakery goods.

In illustrative embodiments, the branding conveyor properly meters four baking pans. Branding presses move upstream so that they are aligned with the four baking pans. Once aligned, the baking pans and the branding presses move together downstream along the branding conveyor while the branding press heads are lowered onto the bakery goods in the baking pans for a preset dwell time. Once the dwell time is completed, the branding press heads are raised up and the branding presses are again shuttled back upstream to pair up with another four baking pans that have been properly aligned by a metering conveyor.

These and other features of the present disclosure will become more apparent from the following description of the illustrative embodiments.

### BRIEF DESCRIPTION OF THE DRAWINGS

FIG. 1 is a perspective view of a branding system showing four branding presses positioned above a conveyor that contains five pans of buns with four pans positioned beneath branding press heads;

FIG. 2 is an enlarged perspective view of the branding press heads of FIG. 1 and showing the horizontal gear rack and rails that are used to shuttle the branding presses along the conveyor;

FIG. 3 is a perspective view of the branding presses with the branding press heads positioned above the conveyor;

FIG. 4 is a perspective view of the branding presses of FIG. 3 with one of the shuttle support rails removed to show the wheels of the branding presses;

FIG. 5 is a perspective view of the branding presses with the shuttle support rails removed;

FIG. 6 is a perspective view of the branding presses with the branding conveyor removed;

FIG. 7 is a perspective view of a pair or branding presses and also showing a conveying motor used to convey the branding presses along the conveyor;

FIG. 8 is another perspective view of the branding presses of FIG. 7 on a shuttle platform;

FIG. 9 is another perspective view of a branding press;

FIG. 10 is a right side elevational view of the branding press;

FIG. 11 is rear view showing of the branding press;

FIG. 12 is a left side elevational view of the branding press;

FIG. 13 is a perspective view of a pair of branding presses mounted on a shuttle;

FIG. 14 is a perspective view of four branding presses mounted in position with the conveyor and showing the branding press heads in an elevated position above the baking pans below;

FIG. 15 is a perspective view of four branding presses mounted in position with the conveyor and showing the branding press heads in a lowered position onto the baking pans to brand the bread in the pans; and

FIG. 16 is a perspective view of the branding plates mounted on the branding press head.

### DETAILED DESCRIPTION

For the purposes of promoting an understanding of the principles of the disclosure, reference will now be made to a number of illustrative embodiments illustrated in the drawings and specific language will be used to describe the same.

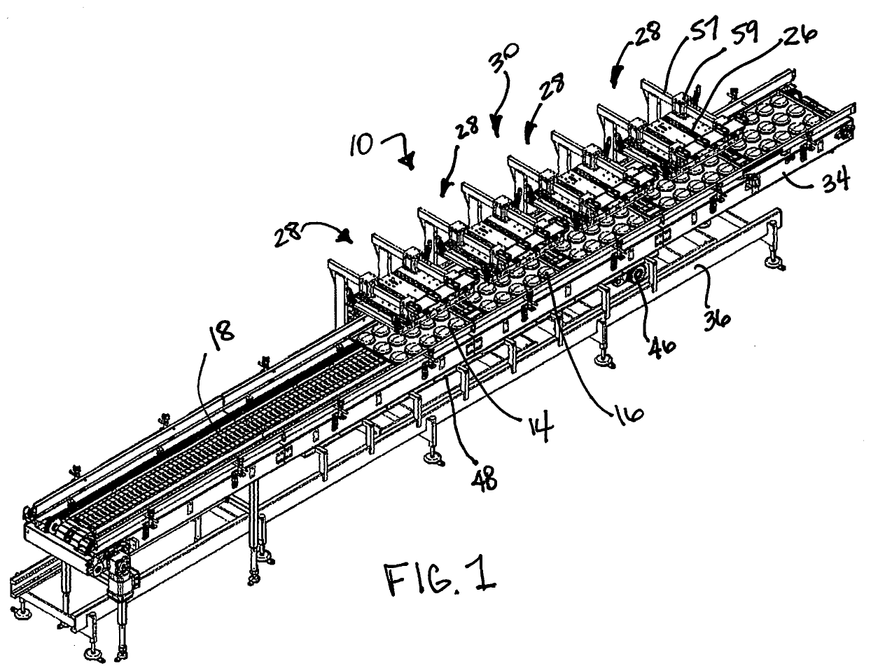

A high volume branding system 10 is shown in FIG. 1. The high volume branding system 10 is part of a commercial baking process. The branding system is integrated into a commercial baking process that includes an oven. Rows of baking pans 14 containing individual baked goods 16 exit the oven and are transferred onto a branding conveyor 18. Each pan 14 typically includes fifteen to twenty four buns or other food products in each pan. While twenty four baked goods are preferred, the baking pans 14 can be designed to hold various amounts of goods. Pans 14 includes recesses to hold the baked goods and can include a row of five recesses by three recesses for fifteen four recesses. Pans 14 include a length direction and a width direction. The pans 14, in one embodiment, include four recesses in the width direction and six recesses in the length direction. While a 4×6 recessed pan is preferred, other pan configurations can be used with varying numbers of recesses such as 3×6 or 4×5.

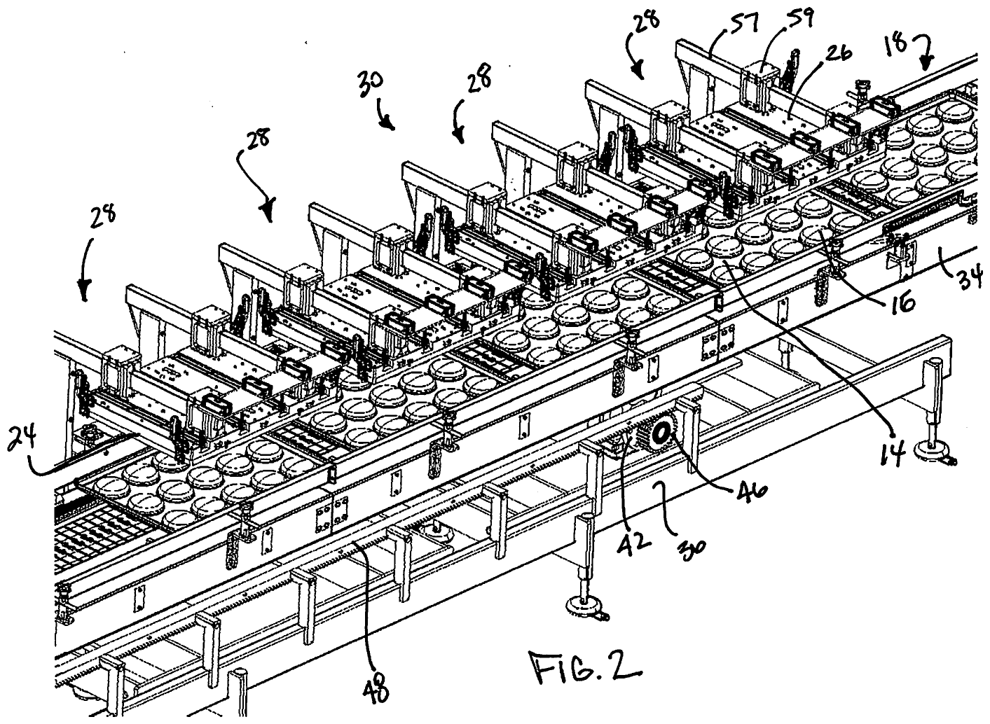

A pan metering conveyor meters pans 14 onto branding conveyor 18, as shown in FIGS. 1 and 2. Pans metering conveyor 24 conveys four pans 14 to the pans metering conveyor 24. Once on the metering conveyor 24, four pans 14, in spaced orientation, will move under four branding presses 28 at the branding station 30. At this point, branding conveyor 18 momentarily stops with four pans 14 to allow for the branding process to be initiated.

The metering conveyor moves the pans 14 intermittently onto the branding conveyor 18. The intermittent pan movement of the metering conveyor 24 is controlled by a timer. The branding conveyor 18 includes spring-loaded pan pushers/aligners that are used to adjust the position of the pans 14 on the branding conveyor 18 to ensure proper placement of the pans 14 under the branding presses 28 so that the images applied by the branding presses 28 are properly centered on the baked goods 16 to be branded.

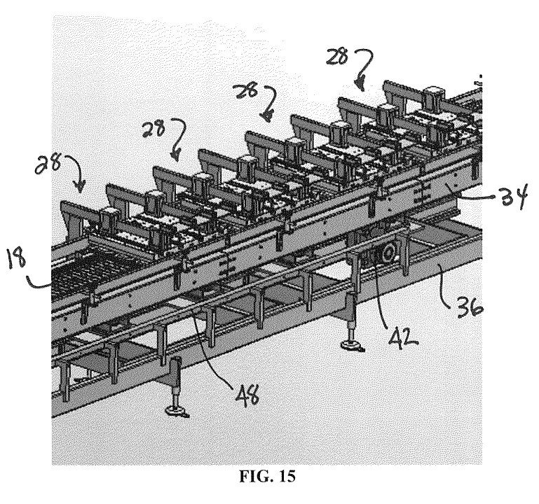

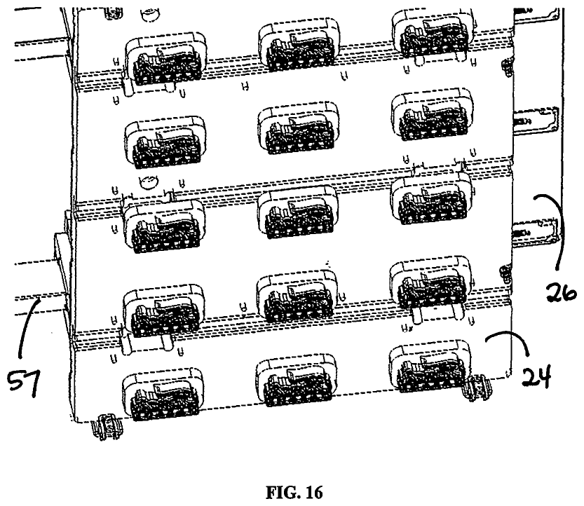

The pan pushers/aligners capture each pan 14 and move it forward one pan length intermittently until the four pans 14 are in the que on the branding conveyor 18, as shown in FIG. 2. As the four pans 14 load and group into the branding conveyor 18, the four branding presses 28 shuttle back upstream over the four pans 14 in que and the servo driven branding presses 28 send down branding press heads 26 to brand the product, as shown in FIGS. 14 and 15. Together the four branding presses 28, which form a branding press assembly, shuttle along with the four pans 14 and move forward along the branding conveyor 18 at pre-adjusted speed during the brand burning cycle. Once baked goods 16 are branded, the pans 14 are shuttled downstream onto a depanner machine.

Branding station 30 is a shuttle design that shuttles the branding presses 28 back and forth. Four branding presses 28 go over the four pans 14, each containing baked goods 16. Servo lift motors 53 vertically move branding press heads 26 and branding plates 24 of branding presses 28 vertically downward and make contact with all of the baked goods 16 in the four pans 14 simultaneously to start branding. The four pans 14 again begin to move along branding conveyor 18 along with the four branding presses 28 so that the pans 14 and branding presses 28 are moving in unison.

Branding press heads 26 are electrically heated so that the images of the branding plates 24 are branded onto the baked goods 16 located in the pans 14, as shown in FIGS. 4 and 15. Branding presses 28 move forward together downstream with pans 14 for a branding cycle or dwell time of approximately seven seconds. After the branding cycle is over, the four branding press heads 26 of the branding presses 28 are lifted up vertically by the servo lift motors 53 and the branding presses 28 are moved upstream by shuttle motor 42 to the start of the branding conveyor 18 to align with four new pans 14 and the branding cycle starts over. The branding cycle is continuous and the pans move through the branding station 30 nonstop.

The branding presses 28 include electric heaters positioned above branding plates 24, which heat up the branding press head plates 24. By PLC controls, the four branding press heads 26 and plates 24 of the branding presses 28, operated by servo lift motors 53, lower down on to the top of the baked goods 16 and gently press and burn the brand image into the buns, in one example. A sample image that could be branded includes the logo from a sports team, for example. After a preset/preprogrammed time, the branding press heads 26 of the branding presses 28 lift up while the branding conveyor 18 continues to convey the four pans 14 onward to a depanner machine, which is used to remove the buns from the pans 14 via suction or other means.

The four pans 14 together with branding presses 28 shuttle forward to complete the branding cycle time and the branding press heads 26 of the branding presses 28 raise up off the now branded product and the pans 14 continue to depanner. The branding cycle repeats itself by the branding presses 28 moving upstream to align with another four pans 14. The motion/branding cycle continues without interruption to the overall baking operation and is continuous. The four branding presses 28 shuttle back to pick up the next four pans 14 with products repeating the continuous cycle. Any time lost in the metering conveyor 24 is made up by increasing the speed of the branding conveyor 18.

FIG. 2 illustrates the branding station 30. Branding conveyor 18 is supported by a frame members 34. Branding conveyor 18 conveys pans 14 and baked goods 16 in a downstream direction. At the same time, branding station 30 shuttles branding presses 28 along with pans 14. Branding station 30 includes frame members 36 that supports mobile platforms 38 that allows branding presses 28 to move upstream and downstream. Frame members 36 include channels 40 that accept wheels 44 of mobile platforms 38 to allow mobile platforms 38 to travel down frame members 36. There is one mobile platform 38 for each pair of branding presses 28. Branding station also includes a shuttle motor 42 that rotates gear 46 on gear rack 48 to move mobile platforms 38. Branding presses 28 are each suspended above pans 14 by upper and lower arms 50, 51 that are configured to telescope with respect to each other by use of lift motor 53.

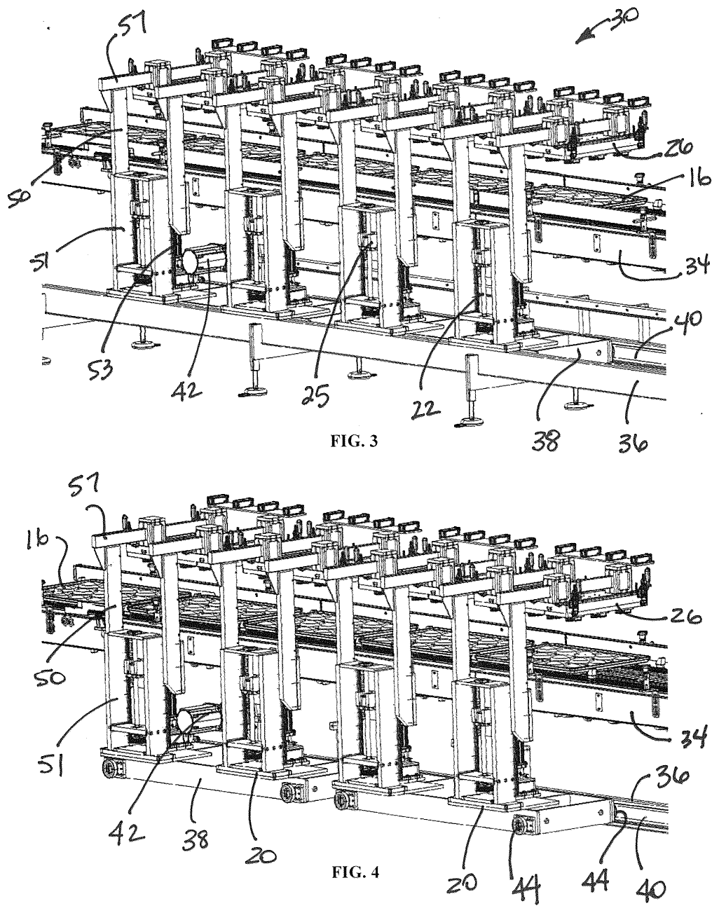

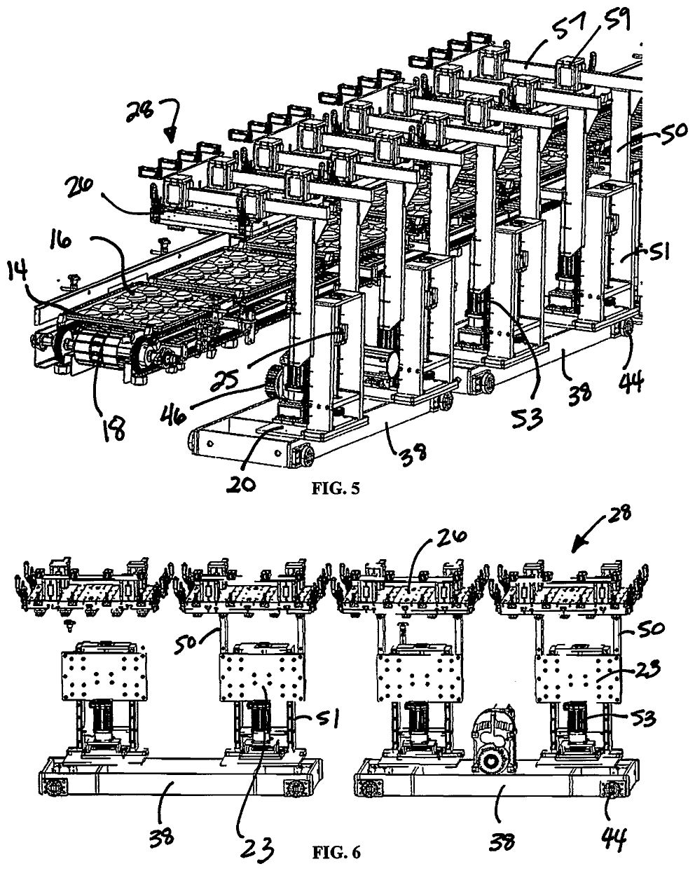

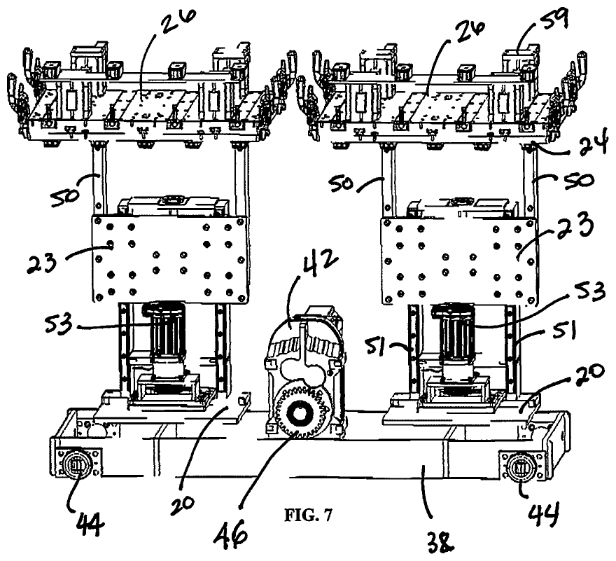

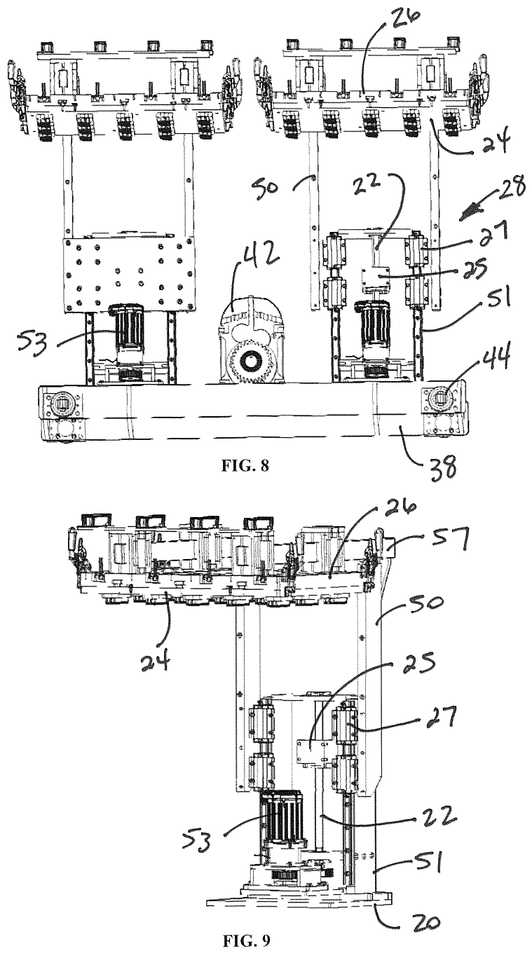

Each branding press 28 includes a base plate 20, as shown in FIGS. 3-7. The base plate 20 is secured to the mobile platform 38. Lower arms 51 and lift motors 53 are secured to the base plate 20. Lift motor 51 includes a lift screw 22 that is coupled to support plate 23. Motor 53 is coupled to lift screw 22 by use of a drive belt or drive gears to rotate lift screw 22 to raise and lower shuttle 25 that is coupled to support plate 23. The lift mechanism also include slide supports 27 that slide along lower arms 51. Upper arms 50 are coupled to support plate 23 and are raised and lowered by lift screw 22 and lift motor 53.

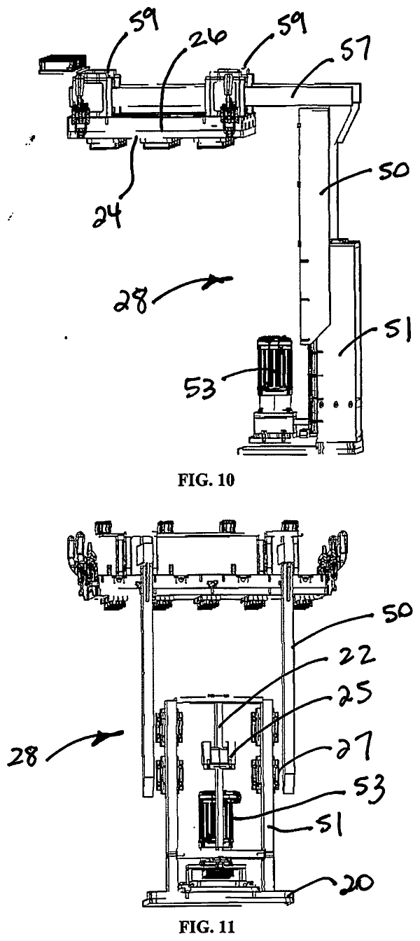

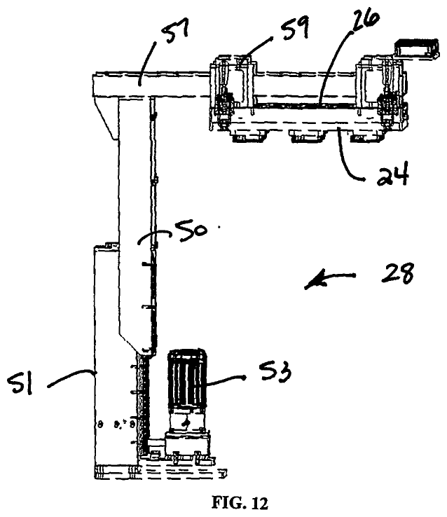

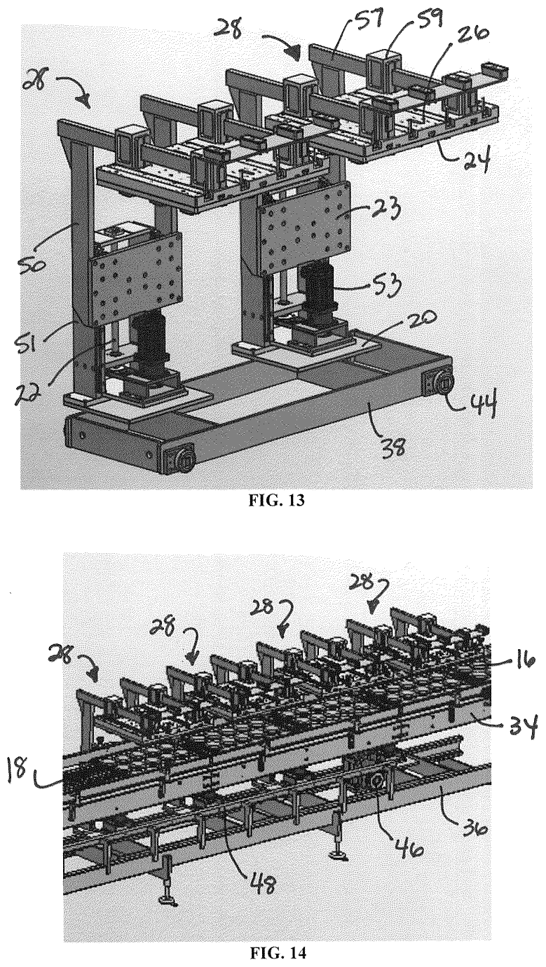

Each branding press 28 also include horizontal arms 57, which are coupled to upper arms 50, as shown in FIGS. 9-12. Horizontal arms 57 are configured to support branding press head 26, as shown in FIG. 10. Press heads 26 are coupled to horizontal arms 57 by adjustable anchor trolleys 59. Anchor trolleys 59 allow press heads 26 to be horizontally adjustable to properly locate and align the branding plates 24 over the pans 14. Branding press heads 26 also include heating elements that heat the branding plates 24 to a temperature high enough to brand a desired logo into the baked goods 16 when branding plates 24 make contact with the baked goods. The design of the branding system isolates the branding press heads 26, heaters and branding plates 24 from sensitive electronics and motors which is all located below the branding press heads 26 and away from damaging heat.

FIGS. 2-4 are side perspective views of branding station 30 illustrating four branding presses 28 that include four branding press heads 26 with branding plates 24 that are independently controlled in the vertical direction by servo lift motors 53. Cable tracks, not shown, can be used to secure the wiring for the servo motors and heaters used to heat branding presses 28. Branding presses 28 are configured to move in unison along with branding conveyor 18. Branding presses 28 are configured to be aligned with pans 14 so that branding is properly applied to baked goods 16.

FIG. 16 illustrates an enlarged perspective view of the branding plates 24. Branding plates 24 are removably coupled to branding press heads 26 so that branding plates 24 can be swapped out for plates with different imprint patterns. Branding plates 24 come into contact with baked goods 16 in pans 14. Branding press heads 26 are connected to branding press 28 by horizontal arms 57. Heating elements are positioned in branding press heads 26 to heat branding plates 24 so that they are hot enough to brand baked goods 16.

Branding presses 28 of branding station 30 have branding press heads 26 and branding plates 24 that move in unison by use of shuttle motor 42. Each branding press head 26 is raised and lowered by a servo lift motor 53 that is used to raise and lower the branding press heads 26 and branding plates 24 onto baked goods 16 in pans 14. Branding presses 28 are shuttled along track 36 at the same rate as the branding conveyor 18 so that branding plates 24 can make contact with pans 14 and have dwell time as they move along with conveyor 30. FIG. 14 is a perspective view of a pair of branding presses 28. Branding press heads 26 include “T” shaped slots that accept “T” shaped members of branding plates 24 that are configured to allow branding plates 24 to slide into and be secured in branding presses 28. This arrangement allows for a user to quickly switch out branding plates 24 for ones with different indicia.

FIG. 2 shows the gear rack 48 that is used by the shuttle motor 42 to shuttle the four branding presses 28 upstream and downstream along the branding conveyor 18 so that the branding press heads 26 can be aligned with the trays 14 and to provide enough dwell time so that the branding plates 24 can adequately brand the indicia into the baked goods 16. After the indicia is branded into the baked goods 16, the branding plates 24 and branding press heads 26 are raised upward by lift motor 53 and the branding presses 28 are shuttled back upstream to align with the next set of four pans 14 that contain goods 16 that are in need of branding. With the present arrangement, branding occurs while the pans 14 and baked goods 16 are continuously being conveyed, which results in branding of product without any significant reduction in line speed. Shuttle motor 42 used to shuttle the branding presses 28 along gear rack 48. FIGS. 18 and 19 illustrate a branding plate 58 and pans 14 used in the process.

In use, after the pans with baked goods leave a tunnel oven, the pans 14 are moved over to a metering conveyor. The metering conveyor meters four pans 14 onto the branding conveyor 18. The four pans 14 are conveyed downstream along the branding conveyor 18. While the pans 14 are moving, the branding station 30 aligns the four branding presses 28 with the four pans 14 by moving the branding presses 28 along the gear rack 48 by use of the shuttle motor 42. The shuttle motor 42 is preferably a servo motor to allow for exacting positioning of the branding press heads 26 with respect to the pans 14.

Branding presses 28 move along with the pans 14 as they are conveyed down the branding conveyor 18. Servo lift motors 53 then rotate to cause lift screw 22 to move the branding press heads 26 and branding plates 24 downward so that the branding plates 24 can brand the baked goods 16, as shown in FIG. 15. Branding plates 24 are electrically heated by heating elements to a temperature that will leave a good branding impression on the baked goods in about 5 to 15 seconds of contact time between the branding plates 24 and the baked goods 16.

Once the impression is branded onto the baked goods, the branding plates 24 are raised by the servo motors 53 and the branding presses 28 are moved upstream back to the start of the branding conveyor 18 by use of shuttle motor 42 and aligned with the next four pans of baked goods in need of branding. While four pans in the illustrative embodiments, it is contemplated that four or less or four or more pans could be used as needed.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A high volume branding system for branding baked goods arranged in pans comprising:
a branding conveyor for receiving the baked goods and conveying the baked goods downstream;
a branding station having a branding press, the branding press configured to travel downstream along the branding conveyor in a first direction and upstream in a second direction;
the branding press configured to align a branding press head with the baked goods on the branding conveyor while the baked goods are moving downstream along the branding conveyor;
the branding press head including a branding plate that is heated and lowered with the branding press head onto the baked goods while the branding press is moving downstream along with the baked goods to brand indicia onto the baked goods;
wherein when the indicia is branded onto the baked goods, the branding press head and branding plate are raised and the branding press is moved in the second direction to align the branding press head with another one of the baked goods on the branding conveyor.

2. The high volume branding system of claim 1, including a series of branding presses.

3. The high volume branding system of claim 1, wherein each branding press head includes a branding plate that includes indicia that is branded onto the baked goods when the branding plate is heated and brought into contact with the baked goods.

4. The high volume branding system of claim 2, wherein the branding press includes at least one motor that is used to rise and lower the branding press head from a first position to a second position and from the second position to the first position.

5. The high volume branding system of claim 1, wherein the branding press is moved along a track.

6. The high volume branding system of claim 5, wherein the branding press includes a shuttle motor.

7. The high volume branding system of claim 6, further including a gear rack, wherein the shuttle motor drives a gear along the gear rack to move the branding press in the upstream and downstream directions.

8. A high volume branding system for branding baked goods comprising:
a branding conveyor for receiving the baked goods and conveying the pans downstream along the conveyor;
a branding press being configured to travel downstream along the branding conveyor in a first direction and upstream in a second direction;
the branding press configured to align a branding press head with the baked goods located on the branding conveyor while the baked goods are moving downstream along the branding conveyor;
the branding press each includes a branding press head and a branding plate that is heated and lowered with the branding press head onto the baked goods while the branding press is moving downstream along the conveyor to brand indicia onto the baked goods;
wherein when the indicia is branded onto the baked goods, the branding press heads and branding plates are raised and the shuttle is moved in the second direction to align the branding press heads and branding plates with another number of unbranded baked goods on the branding conveyor.

9. The high volume branding system of claim 8, wherein the branding press includes at least one motor that is used to rise and lower the branding press head from a first position to a second position and from the second position to the first position.

10. The high volume branding system of claim 8, wherein the branding press is moved along a track.

11. The high volume branding system of claim 8, wherein the branding press includes a shuttle motor.

12. The high volume branding system of claim 11, further including a gear rack, wherein the shuttle motor drives a gear along the gear rack to move the branding press in the upstream and downstream directions.

13. A high volume branding system for branding baked goods comprising:
a metering conveyor for receiving the baked goods and conveying the pans downstream;
a branding conveyor downstream from the metering conveyor, the branding conveyor configured to receive the pans from the metering conveyor and conveying the pans downstream;
a plurality of branding presses, each having a branding press head, the branding presses being configured to travel downstream along the branding conveyor in a first direction and upstream against the direction of the branding conveyor in a second direction;
the branding presses are configured to align the branding press heads with a corresponding number of the baked goods located on the branding conveyor while the pans are moving downstream along the branding conveyor;
the branding press heads are configured to be lowered onto the baked goods while the branding presses are moving downstream in sync with the baked goods along the branding conveyor to apply indicia onto the baked goods;
wherein when the indicia is branded onto the baked goods, the branding press heads are raised off of the baked goods and the branding presses are moved in the second direction to align the branding press heads with another number of baked goods on the branding conveyor.

14. The high volume branding system of claim 13, wherein the branding presses include at least one motor that is used to rise and lower the branding press heads from a first position to a second position and from the second position to the first position.

15. The high volume branding system of claim 14, wherein the branding presses are moved along a track.

16. The high volume branding system of claim 15, wherein the branding presses include a shuttle motor.

17. The high volume branding system of claim 16, further including a gear rack, wherein the shuttle motor drives a gear along the gear rack to move the branding presses in the upstream and downstream directions.

18. The high volume branding system of claim 13, wherein each branding press includes a branding plate that includes indicia that is applied onto the baked goods when the branding plate is brought into contact with the baked goods.

19. The high volume branding system of claim 18, wherein the branding plates are heated so that the indicia is branded onto the baked goods when the branding plates are brought into contact with the baked goods.
